(19) United States
(12) Patent Application Publication
(10) Pub. No.: US 2006/0032380 A1
(43) Pub. Date: Feb. 16, 2006

(54) Filter for extraction device

(76) Inventor: Antonius Klaassen, Huissen (NL)

Correspondence Address: YOUNG & THOMPSON, 745 SOUTH 23RD STREET, 2ND FLOOR, ARLINGTON, VA, 22202, US

(21) Appl. No.: 10/515,993

(22) PCT Filed: May 26, 2003
(86) PCT No.: PCT/NL03/00391

§ 371 Date: Jul. 25, 2005

(30) Foreign Application Priority Data
May 31, 2002 (NL) 1020755

(51) Int. Cl. A47J 31/06

(52) U.S. Cl. 99/295

(57) ABSTRACT

A method and device for preparing an extract with a froth layer, provided with a holder which during use includes a lower filter and an upper filter, each consisting of an outer edge of washable, sturdy material, which fit onto each other, and an inner part of washable material with small holes, and wherein the substance to be extracted is received between the lower filter and the upper filter. A lower filter or upper filter for use in such a device is also disclosed.

The present invention relates to a device for preparing an extract, at least provided with a holder with an inner space in which at least during use an extract is received which corresponds to the substance for extracting to be formed, a standing side wall and an outflow opening for delivering the formed extract, wherein hot water under pressure is supplied on the top side of the holder in order to extract the substance for extracting received in the holder. The present invention also relates to a method for thus preparing such an extract and to a filter for use in such an extraction device.

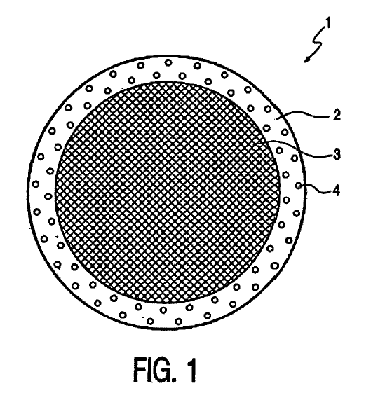

Such a device is known from the European patent application EP 904718 in which an apparatus for preparing coffee with a froth layer is described, wherein a pouch filled with ground coffee is arrange in a holder provided with an access opening for water and an outflow opening for the extracted coffee. After closing of the cover hot water can be supplied, as shown in the reference figure, to duct 40. The reference figure corresponds to FIG. 1 of EP 904718 with a few reference numerals added. This hot water is supplied via cover 34 to the top of the pouch, passes through the pouch and collects as coffee extract in recess 20. The coffee extract then spouts through the spout opening 22 into the collecting reservoir 28. This collecting reservoir 28 is filled with café crème which flows via opening 30 out of the collecting reservoir to leave the housing via outlet opening 26.

The design of this apparatus builds on the apparatus described in the American patent U.S. Pat. No. 5,649,472, although arranged hereon in the apparatus described in EP 904718 are allegedly improved clamping means. In the European patent EP 904717 is described an alleged improvement to this apparatus relating to the position of radial grooves arranged in the bottom of the holder. Such a coffee machine including the use of such grooves is otherwise also known from the American patent U.S. Pat. No. 3,620,155.

In all these devices for preparing coffee with a froth layer, also known as café crème, use is made of a pouch, generally consisting of an upper sheet 8 and a lower sheet 10, each made of filtering paper. The upper sheet and lower sheet are joined together close to their longitudinal edges using a sealing seam. The substance for extracting, such as for instance ground coffee, is present between these sheets.

There are however a large number of drawbacks associated with the use of this pouch. In the first place, separate manufacture of this pouch makes the application expensive. The flexibility in flavour for the consumer further depends on what the manufacturer offers. Finally, there is no possibility for the consumer to vary the strength of the coffee since, in addition to a measured quantity of ground coffee in the pouch, a measured quantity of water is also carried through the pouch.

It has now been found that it is not necessary to supply the amount of substance to be extracted in a precise measure in a pouch. Two washable filters for multiple use, one lower filter to cover the bottom of the holder and one upper filter to cover the substance to be extracted, give the same result as the use of a pouch. This was not to be expected since the supplying of hot water under pressure to the coffee could result in leakage of water and coffee grounds in the apparatus, which, surprisingly, is absolutely not the case. The washable filters to be made to measure for the device can be reused many times without even a single paper filter, let alone a pouch, having to be made and destroyed or recycled each time.

The present invention therefore provides a device of the type stated in the preamble, with the feature that during use the holder comprises a lower filter and an upper filter, each consisting of an outer edge of washable sturdy material, which fit onto each other, and an inner part of washable material with small holes, with the substance to be extracted received between the lower filter and the upper filter. Small holes are understood to mean holes with such a dimension that only the water or the extracted liquid passes through, but that grains of the substance to be extracted or the grounds formed thereby are held back.

The outer edge of at least one of the two filters is preferably manufactured from one or more of the following substances: plastic, metal, wood, stone and ceramic. The outer edges of the two filters are preferably manufactured from the same material. The inner part of at least one of the two filters is more preferably manufactured from one or more of the following substances: metal, plastic, cotton and paper. It is possible for instance to envisage a filter with an outer ring of plastic and an inner portion of metal, for instance iron with very fine holes, as a kind of gauze. Should the holes of the lower filter be too large for a particular application, the addition of a paper filter in the form of the middle part of the filter is of course possible, although generally speaking this will not be necessary. The dimensions of the holes of the upper filter are less critical and will generally be larger than those of the lower filter, as they are intended only for passage of the water carried into the holder to the substance to be extracted.

The form of the filters depends on the form of the holder of the device; it can for instance be rectangular or oval but is preferably round. According to a preferred embodiment of the invention, the outer ring of both the filters to be used is a ring with a width of about 0.001 cm to 2 cm, preferably of about 0.1 cm to 1 cm, more preferably about 0.5 cm; The outer edge of both filters is a ring with a thickness of about 0.001 cm to 1 cm, preferably of about 0.005 cm to 0.02 cm, more preferably about 0.01 cm. Both filters have an outer periphery of about 10 to 25 cm, preferably of about 15 to 20 cm, more preferably about 18.5 cm.

The inner portion of the lower filter which is intended for arranging thereon of the substance to be extracted generally has a greater depth than the upper filter which serves to cover the substance to be extracted. In this patent application the depth of the filter is understood to mean the distance from the top side of the upper edge to below the inner portion of the filter. The lower filter preferably has a depth of about 0.3 to 0.7 cm, more preferably about 0.5 cm, for preparation of about 2 dl of an extract, this depending of course on the strength of the substance to be extracted. In order to prepare about 4 dl of an extract the lower filter has a depth of about 0.7 to 1.3 cm, preferably about 1.0 cm. The upper filter generally has hardly any depth.

When the upper filter is placed on the lower filter and the cover of the device as described above is closed to prepare an extract, the lower and upper filters are generally pressed onto each other so that no leakage of grounds or liquid occurs. Should there however be a chance of the filters shifting relative to each other, for instance when another form of holder is applied, and therefore filters with a shape other than for instance a round shape, such a leakage can then be further prevented by fastening means arranged on the top side of the outer edge of the lower filter and on the top side of the outer edge of the upper filter. These fastening means consist for instance of protruding portions on the top side of the outer edge of the lower filter, while the top side of the outer edge of the upper filter is provided with recesses into which said protruding parts fit, or vice versa. The protruding portions are particularly small studs and the recesses are holes. In another embodiment the outer edges of both filters are held together using magnetic force, wherein either the outer edges are themselves made of magnetic material or are held together using magnetic strips arranged on the outer edges. Also falling within the scope of the invention is the use of a hinge with fastening system between the two filters, preferably connected to the hinge of the cover of the device, whereby the filters preferably coupled to the operating means of the cover of the extraction device can be folded open.

The substance to be extracted is in particular chosen from the group consisting of ground coffee, ground cacao or tea leaves, and more particularly ground coffee.

Another aspect of the present invention forms a method for preparing an extract, characterized in that a device as described above is applied, wherein prior to use the lower filter is arranged in the holder with the deeper inner part downward and the upper edge fitting onto the upper filter upward, the substance to be extracted corresponding to the extract is scooped onto the inner part of the lower filter, the upper filter is placed onto the first filter with the upper edge fitting onto the lower filter downward, so that the substance to be extracted is covered, and after use the filters with grounds of the substance to be extracted are removed, knocked out and/or washed clean and reused as desired. The holder including the filters is preferably rinsed with cold water so that the temperature of the filters is decreased and they can thus be readily taken hold of by hand.

A further aspect of the present invention forms a lower filter or upper filter for use in a device as described above.

The present invention will be further elucidated hereinbelow on the basis of the accompanying embodiments and drawings. Corresponding parts are designated as far as possible in the figures with the same reference numerals.

FIG. 1 shows a top view of the lower filter (1) with outer edge (2) and the inner part (3) and optional recesses such as holes (4)

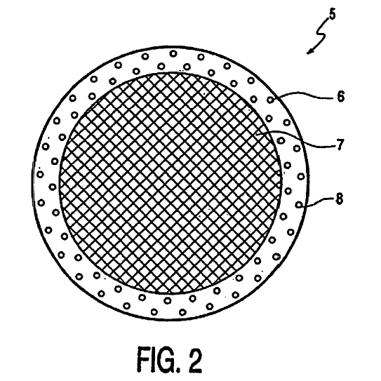

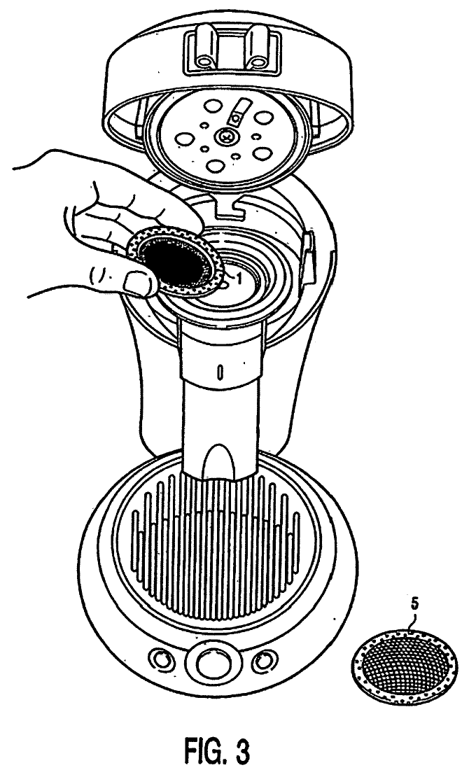

FIG. 2 shows a top view of the upper filter (5) with outer edge (6) and the inner part (7) and optional protruding parts, such as small studs (8)

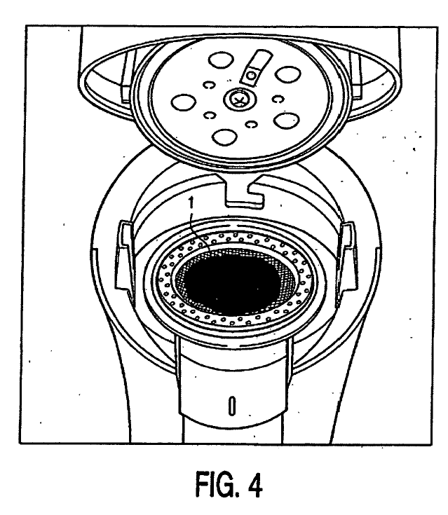

FIG. 3 shows placing of the lower filter (1) in a device for preparing coffee with a froth layer, adjacently of which the upper filter (5) lies ready

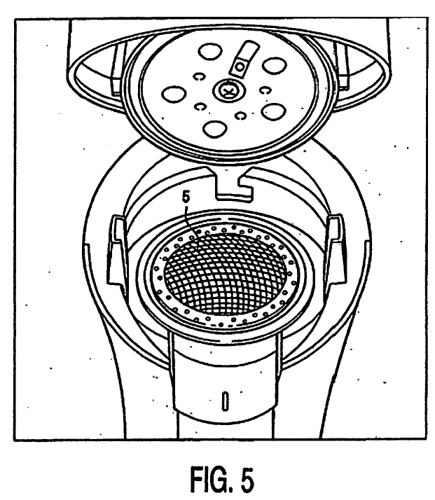

FIG. 4 shows lower filter (1) in a device for preparing coffee with a froth layer, with ground coffee arranged thereon

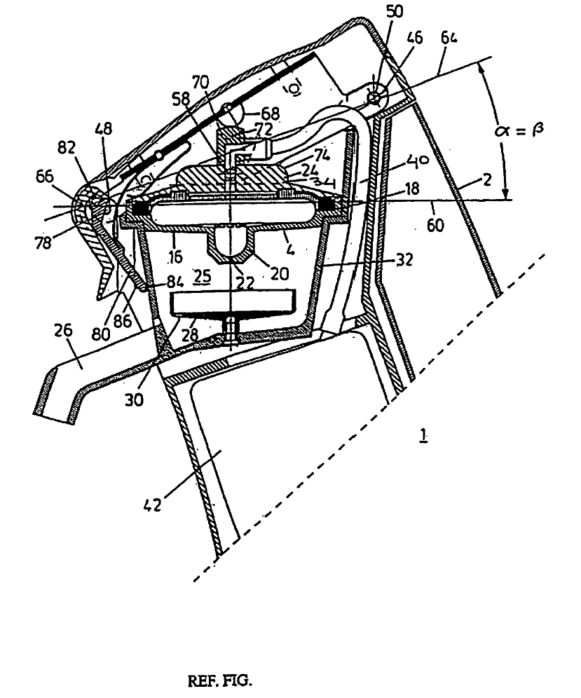

FIG. 5 shows the top side of upper filter (5) arranged to cover ground coffee arranged on the lower filter in a device for preparing coffee with a froth layer.

Finally, for the purpose of clarifying the description a figure is added by way of reference, namely FIG. 1 from the European patent application EP 904718 with several references from this application added.

FIG. 1 shows details of the lower filter for use in the device for preparing an extract with a froth layer, wherein it will be apparent to the skilled person that the dimensions are dependent on the device in which the filter is applied. The depth of the lower filter is suitable for preparing about 2 dl liquid, or when used in a coffee machine in general about one cup of coffee. In order to make two cups of coffee at a time, a filter of twice the depth is suitable. It will be apparent to the skilled person that the form and dimensions of the filter to be used can be further varied, also depending on the form of the holder to be used.

FIG. 2 shows comparable details as indicated for FIG. 1, but then for the upper filter to be applied. Since this filter serves as cover, the depth thereof does not have to be as great as that of the lower filter.

FIGS. 3-5 shows different stages of details of making coffee using a coffee machine for preparing coffee with a froth layer. The coffee machine shown here is known under the name ‘senseo crema’. Instead of arranging a pouch with ground coffee in the holder of the coffee machine, according to the present invention a lower filter is placed in the holder with the deep side of the inner part downward, as shown in FIG. 3. Ground coffee is subsequently scooped as required onto the lower filter with depth in a quantity and a flavour as desired, see FIG. 4. The ground coffee is then covered with the upper filter with the deeper side of the upper part directed upward and the outer edges of the filters against each other. The machine is then closed and started in the usual manner. The coffee extract with froth layer, also referred to as café crème, which is formed by the machine has a composition and taste wholly comparable to the coffee made using ground coffee in a pouch. After the coffee is made the two filters are washed clean and can be reused as required.

In addition to a greater flexibility in amount and type of substance to be extracted which can be used, the application of the above described filters also provides a considerable economic benefit for the consumer. A cup of café crème made according to the present invention gives a price advantage per cup of 150 to 200% compared to the use of a pouch.

Although the invention has been further elucidated in the foregoing with reference to only a single embodiment, it will be apparent that the invention is by no means limited to this given embodiment. A number of other variations and embodiments of the filters according to the invention are possible within the scope of the invention for the skilled person, particularly in respect of the use of different materials with optionally different fastening means on the outer edges, the manufacture of different forms and the use of different dimensions, also depending on the possible applications on different machines with which extracts of different substances with frothy layer can be prepared.

1. Device for preparing an extract with a frothy layer, at least provided with a holder with an inner space in which at least during use an extract is received which corresponds to the substance for extracting to be formed, a standing side wall and an outflow opening for delivering the formed extract, wherein hot water under pressure is supplied on the top side of the holder in order to extract the substance for extracting received in the holder, characterized in that during use the holder comprises a lower filter and an upper filter, each consisting of an outer edge of washable, sturdy material, which fit onto each other, and an inner part of washable material with small holes, and wherein the substance to be extracted is received between the lower filter and the upper filter.

2. Device as claimed in claim 1, characterized in that the outer edge of at least one of the two filters is manufactured from one or more of the following substances: plastic, metal, wood, stone and ceramic.

3. Device as claimed in claim 1, characterized in that the inner part of at least one of the two filters is manufactured from one or more of the following substances: metal, plastic, cotton and paper.

4. Device as claimed in claim 1, characterized in that both filters are round.

5. Device as claimed in claim 4, characterized in that the outer edge of both filters is a ring with a width of about 0.001 cm to 2 cm.

6. Device as claimed in claim 4, characterized in that the outer edge of both filters is a ring with a thickness of about 0.001 cm to 1 cm.

7. Device as claimed in claim 4, characterized in that both filters have a periphery of about 10 to 25 cm.

8. Device as claimed in claim 4, characterized in that the lower filter has a depth of 0.3 to 0.7 cm.

9. Device as claimed in claim 4, characterized in that the lower filter has a depth of 0.7 to 1.3 cm.

10. Device as claimed in claim 1, characterized in that the substance to be extracted is chosen from the group consisting of ground coffee, ground cacao or tea leaves.

11. Method for preparing an extract with a froth layer, characterized in that a device as claimed in claim 1 is applied, wherein prior to use the lower filter is arranged in the holder with the upper edge fitting on the upper filter upward, the substance to be extracted corresponding to the extract is scooped onto the inner part of the lower filter, the upper filter is placed on the first filter so that the substance to be extracted is covered, and after use the filters with grounds of the substance to be extracted are removed, knocked out and/or washed clean and reused as desired.

12. Lower filter for use in a device as claimed in claim 1.

13. Upper filter for use in a device as claimed in claim 1.
